(19) United States
(12) Patent Application Publication
(10) Pub. No.: US 2026/0254759 A1
(43) Pub. Date: Aug. 27, 2026

(54) System and Method for Engineering Bounded Latency for Network Switching Devices in a Packet Transmission Network

(71) Applicant: Canoga Perkins Corporation, Chatsworth, CA (US)

(72) Inventors: David Alan UNTRAUER, Los Angeles, CA (US); Anees Ali NARSINH, Pacific Palisades, CA (US); Thomas Tranh TRAN, Simi Valley, CA (US); Lucas Koy LAWRENCE, Castaci, CA (US)

(21) Appl. No.: 19/466,857

(22) Filed: Feb. 2, 2026

Related U.S. Application Data
(60) Provisional application No. 63/762,386, filed on Feb. 24, 2025.

(51) Int. Cl. H04L 47/125; H04L 41/12

(52) U.S. Cl. CPC H04L 47/125; H04L 41/12

(57) ABSTRACT

A method and system for predictive and validated bounded latency in a packet transmission network. The predictive and validated bounded latency is achieved by a combination of several network protocols referencing network level information monitored and controlled by a network controller external to each network device, including multi-level admission control, predictive data path computation, instrumentation built into each network device of the packet transmission network, and a network level topology view. As new virtual circuit requests are received, the network controller identifies whether network resources are available to meet the virtual circuit parameters without exceeding the bounded latency of the network whereupon corrective actions are implemented to address network resource deficiencies, if necessary, prior to accepting the virtual circuit request. Upon acceptance, the network controller configures the network devices to support the accepted virtual circuit.

### CROSS-REFERENCE TO RELATED APPLICATIONS

This application claims the benefit of U.S. Provisional Application No. 63/762,386, filed February 24, 2025, hereby incorporated by reference in its entirety.

### FIELD OF THE INVENTION

The present invention relates to predicting, validating, and controlling latency (also referred to as engineering latency, bounded latency, or engineering bounded latency) in network switching devices of packet transmission networks (networks).

### BACKGROUND OF THE INVENTION

Typical packet transmission networks, such as Ethernet or IP networks, are inherently an asynchronous transport technology. Individual network devices (i.e., network switches and routers) are not synchronized with each other, and as such, each device makes independent decisions about packet transmission based on localized knowledge of each device’s immediate neighbors. While this addresses latency at a local level, end-to-end latency of the network may not be truly addressed.

A typical packet transmission network consists of: a collection of interconnected network devices (network switches or routers), each device with two or more ports, a unified network level set of forwarding rules which allows a packet to traverse the network from a specific source (ingress switch) to a specific destination (egress switch), and a network management system (network controller), which manages individual network devices and has an aggregated network level view of the overall network configuration and performance.

The end-to-end network level latency in a network is defined herein as the time elapsed from the reception of the first bit of a packet at the ingress port of the first device (ingress switch) in the network until the transmission of the last bit of the same packet at the egress port of the last device (egress switch) in the network.

As packet transmission networks become increasingly time-sensitive, for example 5G networks, controlling latency across the network is crucial to meet tightly constrained latency and jitter requirements of such networks. Traditional networking approaches seek to minimize end-to-end latency across the network, ensuring that packets arrive at a destination in the shortest possible time interval. Alternatively, networks may employ a bounded latency approach, where a worst-case behavior model is utilized to guarantee a maximum allowable end-to-end latency across the network. If properly implemented, a bounded latency approach represents a deterministic networking protocol ensuring that a frame entering the network arrives at the destination within a particular timing window.

One method of optimizing data paths to control end-to-end latency across a packet transmission network is through utilization of resource reservation protocol (RSVP). However, RSVP only uses localized knowledge based on individual switch to switch connections (hop-by-hop connections) and fails to address overall network topology. As such, end-to-end network level latency cannot be properly managed as data path selection decisions fail to account for all potential data paths through the network and merely control latency at the network device level.

Data path selection provides routing protocols of network communications wherein a best path from a source node to a destination node is determined with the goal of optimizing data paths for particular frames with specific timing and latency requirements. This is done by evaluating network metrics including available bandwidth, frame size, expected transmission count, expected transmission time, end-to-end latency, and number of switch-to-switch connections (hops). In this manner, data paths may be selected and tailored for frames corresponding to delivery requirements or user-defined constraints.

To implement data path selection, network topology must be known. Networks can be implemented with a known topology, or the network topology can be discovered by various established protocols and mechanisms for discovery of each neighboring device in the network. For example, some protocols and mechanisms for neighbor discovery which are known in the art include Link Layer Discovery Protocol (LLDP) defined in the IEEE 802.1AB-2017 standard, Service OAM, defined in the ITU-T Y. 1731 (2015) standard, IPv6 Neighbor Discovery Protocol, defined in IETF RFC 4861, Minimum Spanning Tree (MST) analysis, or Time-Aware Shaping defined in the IEEE 802.1Qbv standard. Once the topology of the network is known, a data path between the source node to the destination node is selected. Protocols and mechanisms for data path selection which are known in the art include Open Shortest Path First (OSPF) and Multiprotocol Label Switching for Traffic Engineering (MPLS-TE). Latency across the selected data path can then be measured as defined in the ITU-T Y. 1731 DMM protocol.

End-to-end latency can be further controlled by the implementation of various network protocols including network admission control and data path selection. Network admission control defines and implements policies governing access to network devices within the network from external systems. Specifically, network admission control limits or otherwise inhibits unwanted and unscheduled traffic into a network, so that data paths that have been previously optimized remain optimized within each network device. Network admission control also limits resource oversubscription. Oversubscription can cause increased and unpredictable latency. Network admission control techniques are a commonly implemented using Access Control Lists (ACLs), traffic policing, and stream metering.

While network admission protocols, data path selection, knowledge of network topology, and network device instrumentation to implement the selected protocols are each individually known in the art and governed by multiple existing standards which are directly implemented on the network devices of the packet transmission network, each standard or protocol is traditionally implemented individually to address a limited view of network resource allocation and availability. As the effects of each standard on greater network resources are considered outside of the scope of each standard or protocol, traditional implementations of each standard lead to unpredictability in the packet transmission network. Therefore, there is a need for a system which implements each existing standard or protocol to work in concert to achieve deterministic bounded latency across a time-sensitive network.

One object of the present invention, in a generalized packet transmission network, is to predict, validate, and bound latency across data paths of the network to determine a data path sufficient to meet user-defined network criteria without exceeding a maximum latency by configuring policies implemented by elements of each network device of the network using network level knowledge monitored by a network controller.

### BRIEF SUMMARY OF THE INVENTION

In one aspect the present invention is a system for engineering bounded latency for network switching devices of a packet transmission network using network level information. The system comprises a plurality of interconnected network devices governed by a network controller; the network controller adapted to generate a computational model of the packet transmission network to analyze network resource availability across the packet transmission network for a newly requested virtual circuit, identify a data path fulfilling the bandwidth, latency, and reliability requirements of the requested virtual circuit, and reconfigure the plurality of network devices to fulfill network resource requirements of the requested virtual circuit. If the network controller determines that the network resources are not available, one or more corrective actions are selected to address a deficiency in one or more network resources. The network controller implements methodologies across admission control protocols, data path selection protocols, network device instrumentation, and knowledge of network level topology to generate the computational model of the packet transmission network to determine overall network latency with a high degree of predictability, ensuring all frames traversing the network are delivered within a maximum latency threshold (upper latency bound).

In another aspect the present invention is a method for engineering bounded latency for network switching devices of a packet transmission network using network level information. The method is implemented by a network controller governing the packet transmission network and comprises generating a computational model representing the packet transmission network, analyzing network resource availability across the packet transmission network via the computational model upon receipt of a virtual circuit request, wherein the virtual circuit request includes bandwidth, latency, and reliability requirements. Upon determining that the network resources are available, the virtual circuit is accepted, and each network device of the packet transmission network is reconfigured by the network controller via management of network admission control protocols, data path selection protocols, network device instrumentation, and knowledge of network level topology to determine overall network latency with a high degree of predictability, such that all frames traversing the packet transmission network are delivered within a maximum latency threshold (upper latency bound). If the network controller determines that the network resources are not available, one or more corrective actions are selected to address a deficiency in one or more network resources prior to reconfiguring the plurality of network devices.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims:

FIG. 1(a) illustrates a simplified network diagram.

FIG. 1(b) illustrates a simplified diagram representative of a network device of an exemplary packet transmission network implementing the method for engineering bounded latency of the present invention.

FIG. 2 illustrates the process of engineering bounded latency to guarantee delivery implemented by the system of the present invention.

FIG. 3 illustrates a simplified diagram of an exemplary network controller implementing the method for engineering bounded latency of the present invention.

FIG. 4(a) illustrates the process of validating and accepting new virtual circuit requests to meet bounded latency requirements implemented by the system of the present invention.

FIG. 4(b) illustrates a continuation of the process of validating and accepting new virtual circuits of FIG. 4(a).

FIG. 4(c) illustrates the process of reconfiguring network device elements to correct network resource deficiencies implemented by the system of the present invention.

FIG. 4(d) illustrates the process of configuring forwarding tables to add a new virtual circuit to the network implemented by the system of the present invention.

### DETAILED DESCRIPTION OF THE INVENTION

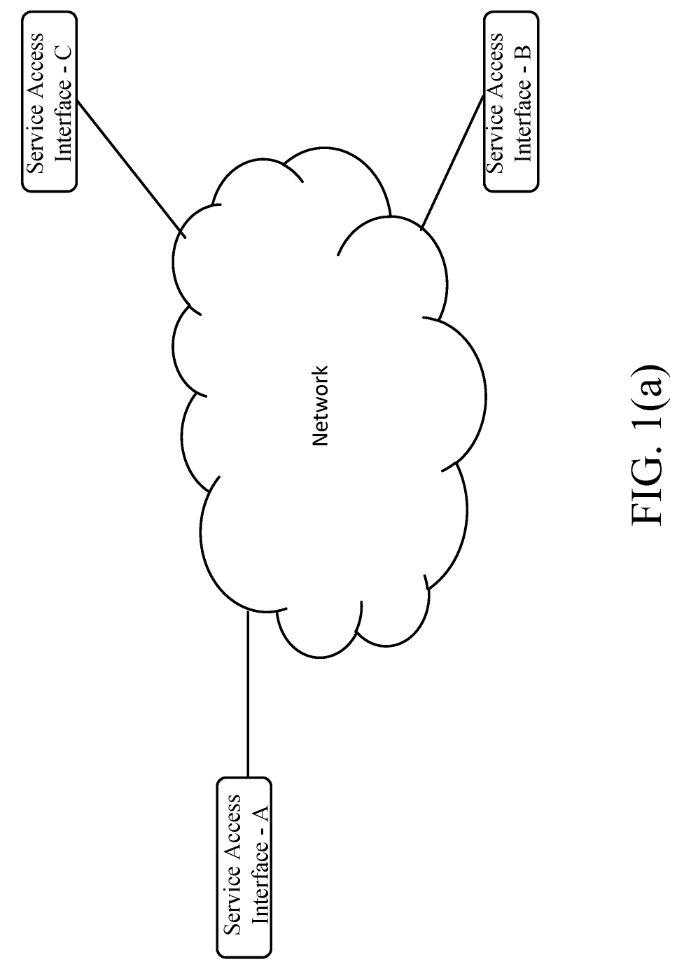

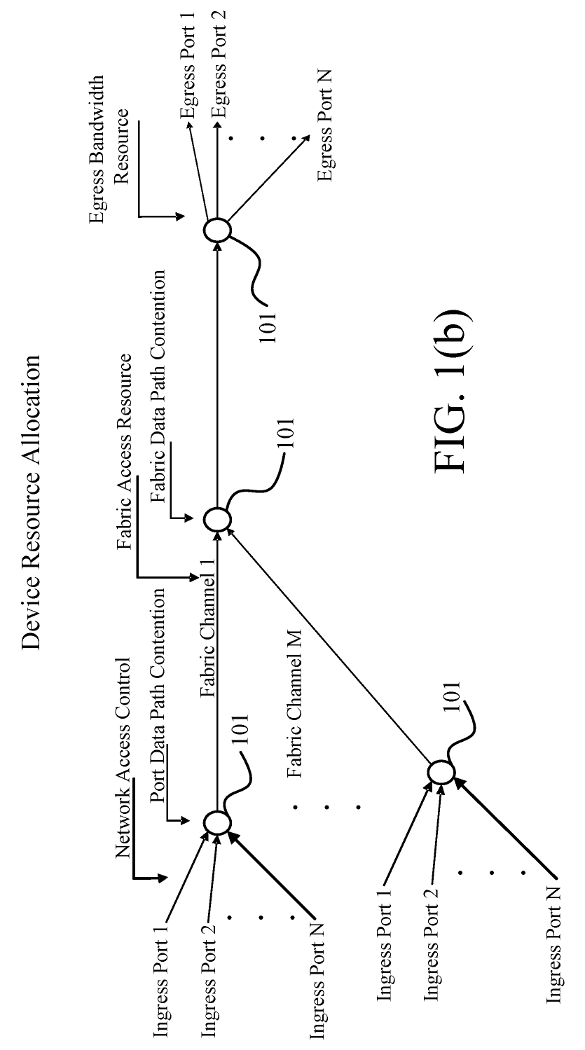

In an exemplary embodiment of the present invention, the latency prediction, validation, and control system comprises a network controller adapted to oversee a packet transmission network and generate a computational model of the packet transmission network, such that the network controller has network level knowledge of the packet transmission network. Generally, as illustrated in FIG. 1(a), the packet transmission network is in communication with a plurality of service access interfaces, which can comprise a variety of service interfaces, including but not limited to industrial machinery, sensor units, user terminals, and the like. The packet transmission network comprises one or more network devices, interconnected in a generic mesh topology. For the purposes of the present disclosure, the network devices are contemplated to comprise network switches, however alternate network devices, such as, but not limited to, routers, bridges, hubs, and repeaters, are also contemplated to be included in the latency prediction, validation, and control system and method of the present invention. In the case of packet transmission networks containing hubs and repeaters, as such network components contribute to network latency but are not controllable, hubs and repeaters represent static elements in the packet transmission network for the purpose of engineering latency.

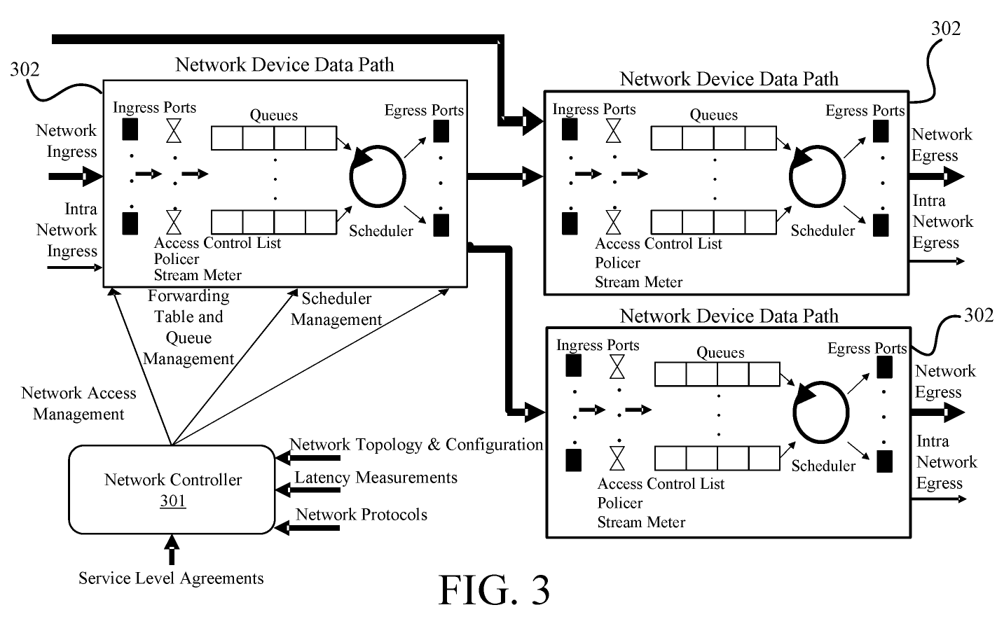

As best illustrated in FIG. 1(b), a simplified network device of a packet transmission network is provided, the network device comprising a plurality of network device components that are evaluated and managed to ensure that network resources of the network device meet the bandwidth, latency, and reliability requirements of the granted virtual circuit. As shown in FIG. 1(b), each network device comprises one or more ingress ports (Ingress Port 1, Ingress Port 2, Ingress Port N) and one or more egress ports (Egress Port 1, Egress Port 2, Egress Port N), wherein each ingress port of the one or more ingress ports is connected to one or more egress ports by one or more fabric channels (Fabric Channel 1, Fabric Channel M). A data path is defined within the network device between an ingress port and the egress port along a fabric channel, wherein the fabric channel may further deliver frames traversing the data path to other interior network device elements or components as further described elsewhere herein in reference to FIG. 3. On a global network-wide scale, the data path further extends across multiple network devices as described above, such that the data path extends between an ingress port of an ingress switch, one or more fabric channels connecting the ingress switch to a desired egress switch, and optionally one or more intermediary switches disposed between the ingress switch and the egress switch. The data paths are determined by utilizing one or more known path prediction protocols reliant on a knowledge of network topology, which in turn is determined by one or more known discovery protocols.

Each network device further comprises a network access control (network admission control) to authenticate only those users and devices that are compliant with security policies of the packet transmission network. In some embodiments, the present system implements multi-level network access control to police traffic at each ingress port and fabric channel connection to provide predictable frame traffic across the packet transmission network. By limiting ingress traffic, non-negotiated traffic which could produce unpredictable behavior in determining latency in the packet transmission network is prevented. Additionally, implementing network access control at the fabric channel controls system level traffic demand through the fabric channel, such as in cases where a fabric channel resource is over utilized (oversubscribed), resulting in traffic through the system becoming unpredictable.

For a given network with a known network topology, network access control enables prediction of a worst-case traffic congestion in each network node, as well as a determination of worst-case network resource utilization. Knowing each of the worst-case traffic congestion and resource utilization as a result of network access control, global knowledge of delays along existing data paths, and a global knowledge of network topology, a computational model of the network is generated by the network controller. The computational model is generated using known network standards and protocols across admission control protocols, data path selection protocols, network device instrumentation, and knowledge of network level topology to determine expected properties of the packet transmission network and accounting for interactions between the utilized protocols. In this manner, instead of an independent analysis and implementation of each protocol in isolation as is known in the art, the utilized protocols are examined in combination to generate a fully predictable and representative computational model of the packet transmission network. Using the generated computational model of the network, proposed data paths for a requested virtual circuit may be evaluated, for example, to determine a maximum latency associated with each proposed data path for the newly requested virtual circuit. As such, the network controller of the present invention is enabled to select a path wherein an expected worst-case latency is less than a latency requirement of a newly requested virtual circuit. In this manner, the bandwidth, latency, and jitter requirements of a requested virtual circuit can be met.

Generally, the computational model is adapted to determine congestion at each of the contention points or network nodes of the network, to evaluate the worst-case latency across a particular data path. For example, at any given unit of time, the amount of data traversing the data path and arriving at each contention point from all data streams passing through the network is known. A worst-case congestion at each contention point can be determined by identifying a maximum packet or data flow associated with each data stream at each contention point and assigning the maximum packet or data flow to each data stream at each contention point. A new virtual circuit is evaluated compared to the worst-case congestion, such that a new virtual circuit delay is determined representative of how long the new virtual circuit must wait to traverse the associated contention point. Summing all delays in worst-case scenarios at each contention point along the selected data path, in addition to transit delays across connections between network devices, a worst-case latency can be determined for the new virtual circuit along the selected data path. If the worst-case latency exceeds the maximum latency threshold, then the new virtual circuit must be denied if congestion cannot be reduced by one or more corrective actions as described elsewhere herein.

Each data path may intersect with alternate existing data paths at one or more ingress ports, one or more egress ports, and one or more fabric channels, such that contention points 101 (bottlenecks) are defined across the packet transmission network where limited network resources are shared across multiple data paths within a particular network device of the packet transmission network. In this manner, data path selection impacts latency predictability and resource calculations as each data path will produce varying amounts of contention points 101 across the packet transmission network. In the illustrated embodiment, contention points 101 may form at a physical ingress port or a physical egress port of the network device (together referred to as port data path contention points) and fabric channel intersections (fabric data path contention points), wherein ingress port resources, egress port resources, and fabric channel resources, respectively, are shared across multiple data paths and the associated virtual circuits. Additional network device elements (also referred to as nodes), such as queues, may represent a contention point 101. As such, network resource availability at each contention point 101, and across the packet transmission network generally varies based on network activity. For example, the number of virtual circuits passing through an exemplary ingress port at a given time introduces resource limitations at the exemplary ingress port, limiting the number of additional (new) virtual circuits that may make use of the exemplary ingress port. As such, the network topology determines the network latency, as it pertains to data paths and contention points 101, both within each network device of the packet transmission network, and between multiple network devices comprising the network topology. Therefore, overall latency predictability depends on interactions between the methods of network admission control, data path selection, network device instrumentation, and network topology. The latency of each data path can be validated by evaluating meta data timestamps stored in each frame, such as an OAM frame, at the ingress port of the ingress switch and the egress port of the egress switch.

Generally, one or more network resources may be impacted by the introduction of a new virtual circuit to existing contention points 101, including bandwidth resources, latency resources, reliability resources, and network access resources. Each of these network resource deficiencies may be identified at one or more contention points 101 as illustrated in the network device of the exemplary packet transmission network of FIG. 1(b). Bandwidth resource deficiencies may include a limitation in the physical ingress port (source port) connected to a source of the virtual circuit, or deficiencies in the path to or within the physical egress port (destination port). Similarly, latency resource deficiencies include excess traffic passing through or destined to a shared port in the packet transmission network, in addition to excess traffic passing through additional network device elements. Reliability resources identify the likelihood of dropped frames along the data path as a result of overloaded network conditions, restrictive traffic policies along the data path, network outages, and the like. Network access resource deficiencies may be a result of inadequate security policies resulting in non-negotiated traffic entering the network leading to unpredictability and undesired expenditure of network resources. By implementing evaluation and control protocols over each virtual circuit requested through the packet transmission network, as identified using the generated computational model, relative to the available network resources, the present invention provides a guaranteed delivery of frames across any virtual circuit or data path present on the packet transmission network within a maximum latency threshold (upper latency bound) as defined by the network administrator or other user. For example, to evaluate a proposed data path for a newly requested virtual circuit, the network controller implements known standards and protocols on the generated computational model to analyze available network resources and determine an available data path which operates within the constraints of the selected maximum latency threshold. Upon identification of an acceptable data path, the network controller then independently configures the packet transmission network, as further defined elsewhere herein, to match the network configuration utilized in the computational model to support the newly requested virtual circuit. As such, new virtual circuit requests are only accepted should the network controller determine that introducing the new virtual circuit does not lead to frames delivered across the new virtual circuit as well as any existing virtual circuit exceeding the maximum latency threshold, as further described elsewhere herein.

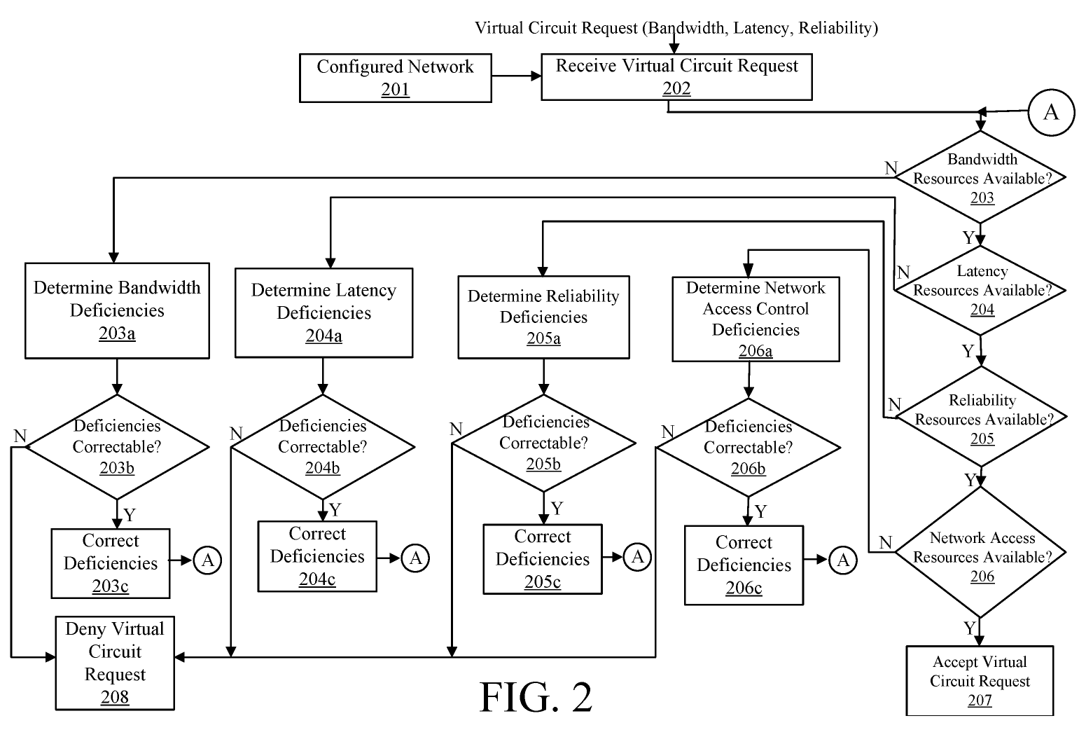

Referring now to FIG. 2, there is shown a flow diagram illustrating the process implemented by the system for engineered latency in a packet transmission network of the present invention. For clarity, the process for accepting virtual circuit requests described below may be applied to a newly configured network interconnected with external access for users of the network, wherein the newly configured network has not yet entered production for its intended end use. Alternatively, it should be noted that the below described process is equally applicable for networks in production where network resource deficiency corrective action priorities shift to minimize downtime of the network, and the associated equipment connected thereto as indicated elsewhere herein. Network configuration is contemplated to comprise known methods and standards for identifying network topology, such as, but not limited to, spanning tree analysis or linked layer discovery protocol (LLDP), as well as known routing methodologies and standards for finding and selecting a data path through the network for each incoming virtual circuit request, such as, but not limited to, open shortest path first (OSPF).

The following process is performed on the computational model generated by the network controller and is implemented for each available data path as identified by the network configuration process to identify network resource deficiencies and potential corrective actions to identify a data path capable of accepting the new virtual circuit without any data paths exceeding the maximum latency threshold. Some corrective actions must be implemented by a user, such as physical modification of the network devices or connections between network devices, as well as the addition of further network devices to the network, whereas other corrective actions are implemented by the network controller with user approval, such as reconfiguration of one or more network devices. When the identified corrective action involves user input, the virtual circuit request is denied and the user is informed of the corrective action. The process will continue to grant or deny further incoming virtual circuit requests while the user determines whether to implement the suggested corrective action, rather than pausing operation until the suggested corrective action is taken. In the case of reconfiguration, acceptance of a requested virtual circuit is delayed until the reconfiguration is complete. The process illustrated in further detail below constitutes a greedy algorithm adapted to determine an available data path most likely to meet virtual circuit requirements without taking unreasonably many steps to arrive at a truly optimal data path.

As shown, once a network is configured at step 201, a new virtual circuit request is received at step 202, the virtual circuit request containing parameters related to the minimally required bandwidth, latency, and reliability associated with the virtual circuit, wherein the configured network parameters and the parameters of the newly requested virtual circuit are compared at the receive virtual circuit request step. To validate and ensure that sufficient network resources exist to accept the new virtual circuit request, the network controller queries sequentially, for each network device and data path in the network, the availability of network resources along the proposed or selected data path. As previously discussed, the analysis illustrated in FIG. 2 is performed for each available data path individually.

Initially, the network controller queries whether sufficient bandwidth resources exist along the selected data path at step 203, wherein a total bandwidth allocated to the existing virtual circuits passing through each node along the selected data path is determined, wherein each node comprises a distinct network device element along the selected data path, such as a port, fabric channel, link, queue, or the like. The network controller determines whether a bandwidth deficiency exists at step 203a, wherein a bandwidth deficiency is determined to exist if the total bandwidth allocated to the existing virtual circuits combined with the requested bandwidth of the new virtual circuit exceeds a bandwidth capacity of one or more nodes along the selected data path. Once a bandwidth deficiency has been identified, the network controller identifies whether the bandwidth deficiency is correctable via one or more corrective actions at step 203b. In the case of a bandwidth deficiency, the corrective actions include adding network devices to the network, reconfiguring the network, adding features to one or more network devices, such as a link aggregation group (LAG) or an equal cost multipath (ECMP), and adjusting an existing scheduling protocol or selecting a new scheduling protocol. In some embodiments, the circumstances of the instant network will determine which of these corrective actions is acceptable to undertake. For example, adding network devices requires taking the network offline, which is undesirable when the network is in production, however if the network is not yet in production, adding network devices may be more desirable than alternative corrective actions as additional network devices may provide the most flexibility for future expansion while addressing the immediate deficiency. Reconfiguring the network is contemplated to include moving existing virtual circuits to a different port, network device, data path, or adjusting the baseline resource requirement for one or more existing virtual circuits (e.g., bandwidth). Such reconfiguration may result in a less efficient virtual circuit, however by rebalancing the network resource consumption across the network, reconfiguration may allow additional virtual circuits to be added to the network without taking the network offline. In a preferred embodiment of the present invention, user-implemented corrective actions, such as adding network devices or external hardware modifications are a lower priority than network controller implemented corrective actions, including reconfiguration of network elements as previously discussed. Once an acceptable corrective action is identified for addressing the bandwidth deficiency, the selected corrective action is taken to address the bandwidth deficiency at step 203c, and the network controller progresses to the next network resource availability analysis.

The network controller then queries whether there is sufficient availability of the next network resource. The network controller next queries whether sufficient latency resources exist in the selected data path to support the new virtual circuit at step 204. The presence of a latency resource deficiency is determined at step 204a when congestion at one or more nodes along the selected data path results in a delay greater than the required latency associated with the new virtual circuit. Once a latency deficiency is identified, the network controller determines whether the latency deficiency is correctable via one or more corrective actions at step 204b, wherein the corrective actions are similar to those available for a bandwidth deficiency, namely adding network devices to the network, reconfiguring the network, and adjusting an existing scheduling protocol or selecting a new scheduling protocol. As with the bandwidth deficiencies, in a preferred embodiment, user-implemented corrective actions are a lower priority than network controller implemented corrective actions, such that impact on network uptime and delays of introducing new virtual circuits are minimized. In some embodiments, preference for which corrective action may be weighted based on the current network status, such as whether the network is in production or pre-production. Once an acceptable corrective action is identified for addressing the latency deficiency, the selected corrective action is taken to address the latency deficiency at step 204c, and the network controller progresses to the next network resource availability analysis.

The network controller then queries whether sufficient reliability resources are available to support the new virtual circuit at step 205. The presence of a reliability resource deficiency is determined at step 205a when rerouting the selected data path to accommodate equipment failure will not satisfy the minimum frame drop rate requirement (minimum required reliability) due to frame loss during data path switchover. Once a reliability deficiency is identified, the network controller determines whether the reliability deficiency is correctable via one or more corrective actions at step 205b, specifically whether one or more redundant data paths will increase the reliability to meet or exceed the value required by the new virtual circuit, or whether a reroute will satisfactorily increase the reliability to meet the required value. Such redundant data paths and reroutes must also satisfy network resource requirements along the newly selected data paths and not interfere with any existing virtual circuits. If a reroute is selected, an existing reroute standard is selected to ensure that network resources for existing virtual circuits are not negatively impacted. Once an acceptable corrective action is identified, the selected corrective action is taken to address the reliability deficiency at step 205c, and the network controller progresses to the next network resource availability analysis.

The network controller then queries whether sufficient network access resources are available to support the new virtual circuit at step 206. The presence of a network access resource deficiency is determined at step 206a when delivery of all requirements of the new virtual circuit is not sufficiently protected. For example, limited hardware resources are available to catalogue and store virtual circuit permissions across each network device. Once a permissions list is full, additional virtual circuits are not capable of being added to traverse the associated network device. Once a network access resource deficiency is identified, the network controller determines whether the network access resource deficiency is correctable via one or more corrective actions at step 206b, including adding another network switch and reconfiguring the network access control to redistribute network access control resources from existing virtual circuits that are not limited by the upper latency bound. As discussed above in relation to previous network resources, user-implemented corrective actions are a lower priority relative to network controller implemented corrective actions to minimize network interruption. Once an acceptable corrective action is identified, the selected corrective action is taken to address the network access resource deficiency at step 206c, and the network controller progresses to the next network resource availability analysis.

Once all network resources are verified to be available to support the new virtual circuit, the new virtual circuit request is accepted at step 207. In the case that any corrective action must be taken, the virtual circuit is accepted upon the application of the desired corrective action. In any instance that a single network resource deficiency cannot be corrected, the virtual circuit request must be denied at step 208.

Referring now to FIG. 3, there is shown an illustration of the network controller of an exemplary packet transmission network implementing the method for engineering bounded latency of the present invention. As illustrated, the network controller is operably connected to each network device of the packet transmission network to provide global (network-level) monitoring and control of each individual network device and node of the packet transmission network. The network controller receives data informing the network controller of the topology and configuration of the packet transmission network as determined by one or more discovery protocols, latency measurement information for each node within the network, and network protocols implemented by the system, for example OSPF. As virtual circuits are requested, accepted, and established, the network controller further monitors all existing virtual circuits and the associated network resource allocation to each virtual circuit across all network nodes.

After a virtual circuit is accepted and assigned a selected data path following the process outlined in FIG. 2, the network controller 301 configures each network device 302 to fulfill the network resource requirements of the accepted virtual circuit. The network controller 301 reprograms field programmable gate arrays (FPGAs) disposed on each of the network devices 302 as further described elsewhere herein to facilitate implementation of the newly accepted virtual circuit. Each individual configuration step as discussed elsewhere herein is contemplated to occur sequentially, however multithreading embodiments may allow simultaneous processing and configuration of network device elements by the network controller 301. Initially, the network controller 301 configures the network access control of each network device 302, modifying the access control list (ACL), policer, and stream meter of each network device 302 to prevent non-negotiated data streams from being transmitted along the selected data path to ensure predictability of frame delivery. In this manner, the network access management step prevents data streams along the selected data path that would otherwise violate the designated bandwidth allocation, latency requirement, or reliability requirement of the accepted virtual circuit. The network controller 301 then updates a forwarding table of each network device 302 to assign the selected data path to the virtual circuit, designating a series of network nodes that frames transmitted via the accepted virtual circuit are to traverse. Depending on the networking technology in use, virtual local area networks (VLANs) are used to enforce a selected path on ethernet network switches, while multiprotocol label switching segment routing (MPLS-SR) is used to enforce the data path on multiprotocol label switching (MPLS) networks, and segment routing over IPv6 (SRv6) is used to enforce the data path on internet protocol (IP) communications networks. Redundant data paths are also defined within the forwarding tables of each network device 302 to ensure reliability requirements of the accepted virtual circuit are met. In this manner, frame loss due to equipment failure or virtual circuit switchover to a different data path is mitigated. Simultaneously, the network controller 301 assigns the selected data path to one or more queues associated with each network device 302, wherein each of the one or more queues are selected to ensure delivery of frames via the virtual circuit arrive at the destination port within the upper latency bound. The network controller 301 selects queues on a per port and per latency requirement basis, such that all frames bound for a shared port that require similar bounded latency are placed in the same queue. Finally, the network controller 301 configures a scheduler disposed on each network device 302, wherein the scheduler governs time gate control of the one or more queues following a designated time schedule. In this manner, the latency variation for frames transmitted along the accepted virtual circuit is reduced. Generally, a terminal ingress port and a terminal egress port of each data path is locked for each virtual circuit as fixed or required transit ports. As such, any non-terminal ports disposed along the data path of the virtual circuit participate in reconfiguration attempts implemented by the network controller 301, while the terminal ingress port and terminal egress port remain fixed.

Furthermore, each of the network devices may optionally be time-synchronized via one or more known precision time protocol (PTP) methodologies. By synchronizing each of the network devices, greater timing accuracy and reliability is achieved, ensuring that frames transmitted across the network arrive at the destination port when expected. However, it should be understood that absent synchronization, as the computational model is generated to represent a complete view of an entire packet transmission network, including delays between each network node, the present invention provides sufficient accuracy and reliability on asynchronous packet transmission networks.

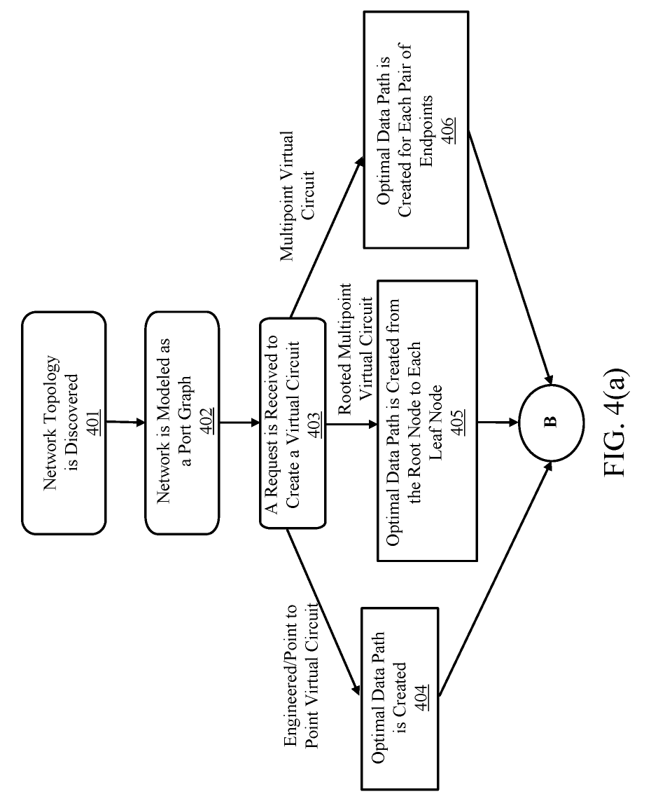

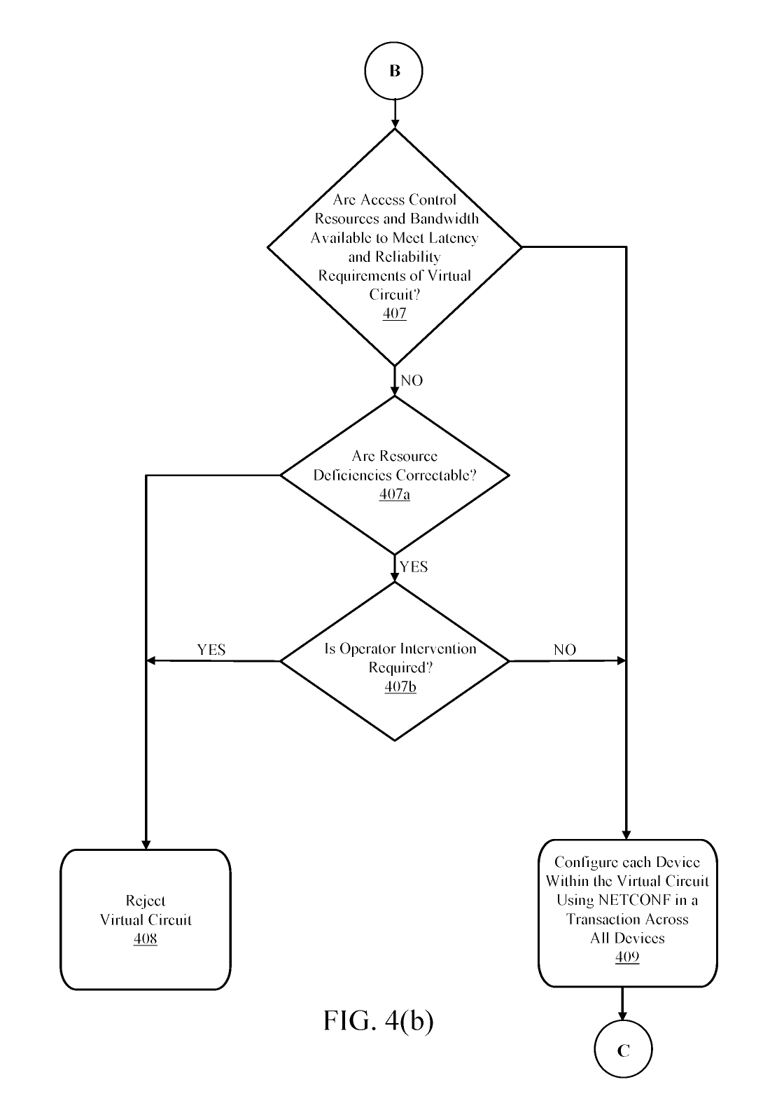

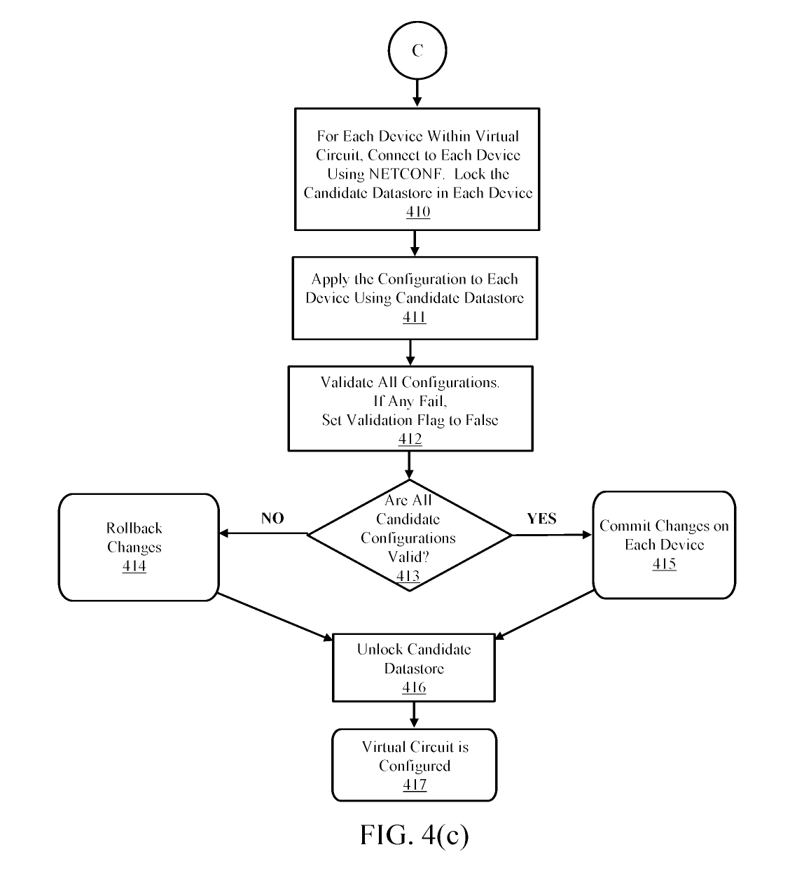

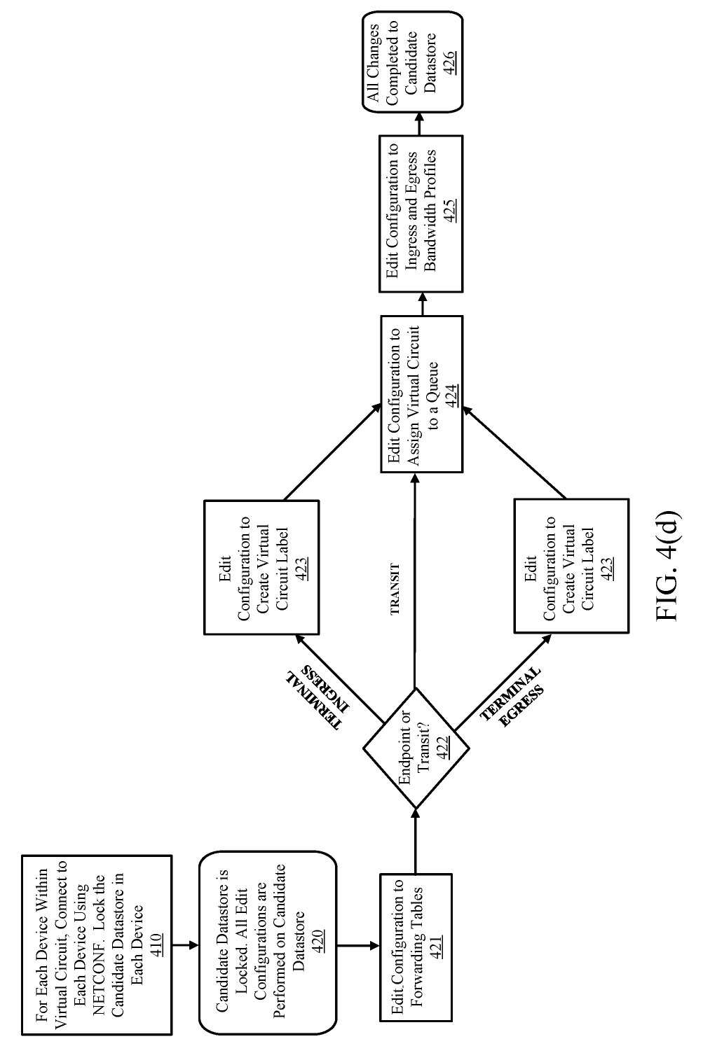

Referring now to FIGS. 4(a) and 4(b), there is shown a flow chart illustrating the process implemented by the network controller to validate and accept newly requested virtual circuits. Initially, a network topology of the packet transmission network is discovered at step 401 using one or more established network discovery protocols, wherein each port in the network connects with each port on a network device element. Utilizing the discovered network topology, the network is modeled as a port graph at step 402, the port graph serving as the basis for the computational model generated to represent the network, wherein a weight of each edge of the port graph represents a latency value across the connection represented by the edge. A request to create a new virtual circuit is received at step 403, which includes origin and destination ports, as well as bandwidth requirements, latency requirements, and reliability requirements. Depending on the type of virtual circuit, different protocols are implemented to find an optimal data path for the requested virtual circuit. For example, in a point-to-point virtual circuit, an optimal data path is created in step 404 using a known protocol, such as OSPF. Alternatively, in a rooted multipoint virtual circuit having a root node and one or more leaf nodes, each optionally having a plurality of intervening nodes therebetween, an optimal data path is created at step 405 using an optimal spanning tree analysis. Finally, in a generalized multipoint virtual circuit, an optimal data path is created for each pair of potential end points of the virtual circuit at step 406, wherein the optimal data path is created using an optimal spanning tree analysis for each pair of potential end points of the virtual circuit. The optimal data path is then checked for network resource availability at step 407, as previously discussed in reference to FIG. 2. If network resource deficiencies are identified that cannot be corrected at step 407a, or if the corrective actions require user (operator) intervention as determined at step 407b, then the virtual circuit request is denied at step 408. Alternatively, if no network resource deficiencies are identified at step 407a or network resource deficiencies are identified that can be implemented directly by the network controller at 407b, the virtual circuit is accepted and each network device is configured to accept the virtual circuit at step 409, wherein network configuration is implemented by a network configuration protocol, contemplated to comprise NETCONF, however it should be understood that other network configuration protocols with similar functionality are also contemplated as part of the present invention.

Referring now to FIG. 4(c), there is shown a flow chart representing the process for reconfiguring the network implemented by the network controller of the present invention. The network configuration protocol comprises a communications protocol adapted to reconfigure each network device of the packet transmission network, wherein the network configuration protocol includes built-in transaction support. The network configuration protocol includes a startup datastore, a candidate datastore, and a running datastore for each network device element and is further configured to lock one or more datastores to prevent editing thereof by any entity other than the entity that initiated the lock, for example, the network controller introducing a new virtual circuit, until predetermined criteria are met. The startup datastore contains information necessary to configure the network device elements upon initialization of the network, for example when resetting the network, during an outage, or after any downtime for maintenance. The running datastore comprises the active datastore necessary to retain configuration information for operating the network and is modified as needed by one or more users or other active processes to introduce new virtual circuits or reconfigure existing virtual circuits across the network. Finally, the candidate datastore represents network configuration data necessary to introduce a new virtual circuit to the network, including network device element configuration information to reconfigure existing virtual circuits to accommodate the new virtual circuit. Each of the datastores is in communication with multiple data streams and may be actively modified in real time by other users or active processes to address any particular network resource demand, however, as new virtual circuits are added by the network controller, one or more datastores must be locked to prevent other users or active processes access to the locked datastore, such that other active users and processes cannot edit the configuration information therein while the reconfiguration to accept a new virtual circuit as described elsewhere herein occurs. The network configuration protocol is further adapted to commit a transaction based off of an ID. As multiple virtual circuits are introduced and active on the network, ensuring that the configuration data for each network device element can be readily isolated to the associated virtual circuit, the configuration data may further comprise an identifier tag. In this manner, when configuration data for an existing virtual circuit is queried or altered to accommodate a new virtual circuit, the correct configuration data may be adjusted.

For each network device along the optimal data path validated by the process illustrated in FIGS. 2, 4(a), and 4(b), the network configuration protocol connects to each network device and locks the network device candidate datastore on each network device at step 410, such that only the network configuration protocol implemented by the network controller may edit the candidate datastore. A save state may further be created recording the state of the candidate datastore prior to editing by the network configuration protocol for each proposed virtual circuit. The network configuration protocol then, at step 411, then applies the previously identified configuration to accept the virtual circuit without exceeding the maximum latency threshold to the candidate datastore of each network device. Once the configurations are applied to the candidate datastore, the configurations are validated at step 412 to ensure that the proposed configuration will result in a virtual circuit that does not exceed the maximum latency threshold, whereupon failing the validation check, a validation flag is set to false. Validation may fail for a variety of reasons, including, but not limited to changing network conditions between selecting the optimal data path for the proposed virtual circuit and implementation of the proposed virtual circuit, individual device failure, communications failure between the network controller and one or more network device elements, and the like. In some embodiments, upon validation check failure, the validation check is repeated a predetermined number of times, whereupon only repeated successive failures result in the validation flag being set to false. Once the validation check is completed, the validation flag is checked at step 413 to ensure that the configuration was properly applied to each network device element for the newly accepted virtual circuit. If the validation flag is false, then the candidate datastore is rolled back to an initial state in step 414, wherein the initial state of the candidate datastore comprises the state of the candidate datastore prior to step 411. If the validation flag is true, then the configuration changes to the candidate datastore of each network device element is committed to each network device in step 415. The candidate datastore is then unlocked in step 416, whereupon the newly accepted virtual circuit is configured at step 417.

Referring now to FIG. 4(d), there is shown a process of configuring forwarding tables to add a new virtual circuit to the network implemented by the system of the present invention. The process illustrated in FIG. 4(d) demonstrates additional steps necessary to configure candidate datastores as previously described in reference to FIG. 4(c). Once the network configuration protocol connects to each network device and locks the candidate datastores located thereon in step 410, the network configurations to prepare the network to accept the new virtual circuit are implemented by performing edits to the candidate datastore 420 of each network device to direct the data stream of the new virtual circuit along the optimal data path selected previously. The network configuration protocol edits the forwarding tables of each network device in step 421, wherein each forwarding table directs the data stream from each node along the data path to a subsequent node along the data path. The network controller further queries whether each instant network device during the reconfiguration process is an endpoint switch (terminal ingress switch, terminal egress switch), or a transit switch (intermediate switch) at step 422. If the instant switch is a terminal ingress switch for the selected data path, the network configuration protocol edits the candidate datastore to create a virtual circuit label at step 423a. The virtual circuit label represents a tag incorporating all platform specific information necessary to identify the virtual circuit, such as ingress port, egress port, pathways, and the like. The virtual circuit label provides an identifier to locate which virtual circuit any particular frame or packet belongs to, such as a service tab (S-tag), MPLS label, or the like. In this manner, the platform specific identifying information is only examined at the terminal ingress switch, whereas the virtual circuit label is referenced at all transit switches. Alternatively, if the endpoint switch is a terminal egress switch, the network configuration protocol edits the candidate datastore to remove the virtual circuit label at step 423b as the label is no longer necessary once the packet or frame has egressed the network. In either case identified in step 422, the candidate datastore is edited to assign the virtual circuit to a designated queue in step 424. The designated queue, as previously discussed, represents a queue assigned on a per port and per latency basis, such that all data streams having similar latency requirements destined for the same port are assigned to the same queue. Next the candidate datastore is edited to create an ingress bandwidth profile and an egress bandwidth profile at step 425. The network ingress bandwidth profile and the network egress bandwidth profile comprise a collection of network access control parameters set by the user, such as, but not limited to, policer settings, bandwidth, flowrate, burst size, and the access control list. Once the ingress and egress bandwidth profiles are created, all remaining configuration changes to the candidate datastore are completed, if any, at step 426. The configurations are then validated, and the process continues as described in reference to FIG. 4(c) about step 412.

The present invention contemplates the implementation of additional protocols and standards as necessary to reconfigure each network device to correct any identified deficiencies, or otherwise to configure each network device to support a given virtual circuit with network resource requirements. The following protocols and standards represent a non-exhaustive list: Path Control and Reservation 802.1Qca, Per Stream Filtering and Policing 802.1Qci, Reliability for Time Sync 802.1AS-2020, Frame Replication and Elimination 802.1CB, Stream Reservation Protocol 802.1Qat, Link-local Registration Protocol 802.1CS, TSN Configuration 802.1Qcc, Foundation Bridge YANG 802.1Qcp, YANG for CFM P802.1Qcx, YANG for LLDP P802.1ABcu, YANG for 802.1Qbv/Qbu/Qci, P802.1Qcw, YANG $ Mib for FRER P802.1CBcv, Extended Stream Identification P802.1CBdb, Resource Allocation Protocol P802.1Qdd, TSN Configuration Enhancements P802.1Qdj, LLDPv2 for Multiframe Data Units P802.1ABdh, Multicast and Local Address Assignment P802.1CQ, Timing and Synchronization 802.1AS-2020, Credit Based Shaper 802.1Qav, Frame Preemption 802.1Qbu and 802.3br, Scheduled Traffic 802.1Qbv, Cyclic Queuing and Forwarding 802.1Qch, Asynchronous Traffic Shaping 802.1Qcr, QOS Provisions P802.1DC.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A system for engineering bounded latency for network switching devices in a packet transmission network, the system comprising:
a packet transmission network comprising a plurality of network devices, the plurality of network devices interconnected by one or more fabric channels to define a network topology having a plurality of data paths;
a plurality of nodes disposed on the plurality of network devices across the packet transmission network, wherein each data path of the plurality of data paths is defined across a subset of the plurality of nodes, the subset of the plurality of nodes including at least a source node, a destination node, and one or more intervening nodes;
a network controller operably connected to each network device of the plurality of network devices, the network controller configured to generate a computational model representative of data congestion at each node of the plurality of nodes via a combination of admission control protocols, data path selection protocols, knowledge of an instrumentation of each network device of the plurality of network devices, and knowledge of the network topology;
wherein the network controller is further configured to execute a bounded latency process on the computational model for each data path of the packet transmission network to manage a plurality of virtual circuits defined between a terminal ingress port and a terminal egress port of the packet transmission network, wherein each virtual circuit of the plurality of virtual circuits is assigned to a data path of the plurality of data paths;
wherein each network device of the plurality of network devices comprises one or more field programmable gate arrays in communication with the network controller, each field programmable gate array programmable by the network controller to implement the plurality of virtual circuits;
wherein the bounded latency process is configured to identify an optimal data path for a requested virtual circuit, the bounded latency process comprising, for each data path of the packet transmission network, the steps of:
a) receiving a request for a new virtual circuit, the request comprising a plurality of parameters required by the new virtual circuit, the plurality of parameters including a maximum latency threshold, a minimum required bandwidth, and a maximum acceptable frame drop rate;
b) determining a total bandwidth allocated to each existing virtual circuit at each node of an instant data path;
c) comparing the minimum required bandwidth to a difference between the total bandwidth and a bandwidth capacity of each node of the instant data path;
d) identifying a bandwidth deficiency exists when the minimum required bandwidth exceeds the difference between the total bandwidth and the bandwidth capacity at any node of the instant data path;
e) determining whether the bandwidth deficiency is correctable via implementation of one or more corrective actions of a plurality of corrective actions;
f) wherein the plurality of corrective actions are selected from a group consisting of: adding one or more supplemental network devices to the packet transmission network, adding one or more hardware modifications to one or more network devices of the plurality of network devices, reconfiguring the packet transmission network, adjusting a scheduling protocol of one or more network devices of the plurality of network devices, selecting a new scheduling protocol for one or more network devices of the plurality of network devices, adding one or more redundant data paths for the new virtual circuit, rerouting one or more existing virtual circuits to a different data path, and reconfiguring a network access control of one or more network devices of the plurality of network devices;
g) implementing the one or more corrective actions identified in step (e) to correct the bandwidth deficiency;
h) rejecting the new virtual circuit if the plurality of corrective actions cannot correct the bandwidth deficiency;
i) determining a latency delay at each node of the instant data path;
j) summing the latency delay at each node of the instant data path to define a total latency delay of the instant data path;
k) comparing the total latency delay of the instant data path to the maximum latency threshold;
l) identifying a latency deficiency exists when the total latency delay exceeds the maximum latency threshold;
m) determining whether the latency deficiency is correctable via implementation of one or more corrective actions of the plurality of corrective actions;
n) implementing the one or more corrective actions identified in step (m) to correct the latency deficiency;
o) rejecting the new virtual circuit if the plurality of corrective actions cannot correct the latency deficiency;
p) determining an expected frame drop rate at each node of the instant data path;
q) comparing the expected frame drop rate to the maximum acceptable frame drop rate;
r) identifying a reliability resource deficiency exists when the expected frame drop rate exceeds the maximum acceptable frame drop rate;
s) determining whether the reliability resource deficiency is correctable via implementation of one or more corrective actions of the plurality of corrective actions;
t) implementing the one or more corrective actions identified in step (s) to correct the reliability resource deficiency;
u) rejecting the new virtual circuit if the plurality of corrective actions cannot correct the reliability resource deficiency;
v) determining available network access control resources at each node of the instant data path;
w) identifying a network access control resource deficiency when the available network access control resources at one or more nodes of the instant data path are insufficient to support the new virtual circuit;
x) determining whether the resource control deficiency is correctable via implementation of one or more corrective actions of the plurality of corrective actions;
y) implementing the one or more corrective actions identified in step (x) to correct the network access control resource deficiency;
z) rejecting the new virtual circuit if the plurality of corrective actions cannot correct the network access control resource deficiency;
aa) accepting the new virtual circuit if no bandwidth deficiency, latency deficiency, reliability resource deficiency, and network access control resource deficiency are identified; and
bb) configuring the plurality of network devices to implement the new virtual circuit using a network configuration protocol.

2. The system of claim 1, wherein the network controller generates the computational model by executing the steps of:
discovering the network topology of the packet transmission network via one or more network discovery protocols;
modeling the network topology as a port graph having a plurality of edges representing a connection between each node of the plurality of nodes; and
assigning a weight to each edge, the weight corresponding to a latency across the connection associated with the edge.

3. The system of claim 1, wherein the optimal data path is identified via implementing one or more protocols selected from a group consisting of: open shortest path first protocol, equal cost multipath protocol, rooted multipoint spanning tree protocol, and paired end point spanning tree protocol.

4. The system of claim 1, further comprising rejecting the virtual circuit subsequent to determining any of the bandwidth deficiency, the latency deficiency, the reliability resource deficiency, and the network access control resource deficiency are correctable by implementing one or more corrective actions of the plurality of corrective actions if the one or more corrective actions identified in any of steps (e), (m), (s), and (x) require operator intervention.

5. The system of claim 4, further comprising the step of notifying the operator of the one or more corrective actions that require operator intervention.

6. The system of claim 1, wherein each network device of the plurality of network devices is time-synchronized to a common grandmaster clock via a precision time protocol.

7. The system of claim 1, wherein the configuring step of step (bb) implemented by the network configuration protocol further comprises the steps of:
connecting to each network device of the plurality of network devices;
locking a candidate datastore of each network device, such that only the network configuration protocol implemented by the network controller is granted edit access to the candidate datastore;
wherein each candidate datastore comprises one or more network configuration datasets associated with the one or more proposed virtual circuits;
recording an initial network configuration dataset stored in each candidate datastore to create a save state of the initial network configuration dataset;
configuring each candidate datastore with a new network configuration dataset identified by the network controller to meet the plurality of parameters required by the new virtual circuit;
validating that the new virtual circuit meets the plurality of parameters using the new network configuration dataset across all nodes of the instant data path;
setting a validation flag to false if the new virtual circuit does not meet the plurality of parameters using the new network configuration dataset;
setting a validation flag to true if the new virtual circuit meets the plurality of parameters using the new network configuration dataset;
checking the validation flag;
restoring the candidate data store to the initial network configuration dataset if the validation flag is set to false;
committing the new network configuration dataset to the candidate datastore of each network device if the validation flag is true;
unlocking the candidate datastore of each network device.

8. The system of claim 7, wherein each candidate datastore is configured with the new network configuration dataset via the network configuration protocol executing, for each network device of the optimal data path, the steps of:
editing a forwarding table stored in the candidate datastore of an instant network device;
querying whether the instant network device comprises a terminal ingress device, a terminal egress device, or a transit device of the optimal data path;
editing the candidate datastore of the instant network device to create a virtual circuit label associated with the new virtual circuit if the instant network device is the terminal ingress device;
removing the virtual circuit label from the candidate datastore if the instant network device is the terminal egress device;
editing the candidate datastore of the instant network device to assign the new virtual circuit to a designated queue;
editing the candidate datastore of the instant network device to create a network ingress bandwidth profile and a network egress bandwidth profile, wherein the network ingress bandwidth profile and the network egress bandwidth profile comprise a user defined set of network access control parameters.

9. The system of claim 7, further comprising repeating the validating step a predetermined number of times if the new virtual circuit does not initially meet the plurality of parameters using the new network configuration dataset.

10. The system of claim 8, wherein the designated queue is selected on a per port and a per latency basis, such that all virtual circuits having similar latency parameters and passing through a shared port are assigned to a shared queue.

11. A method for engineering bounded latency for network switching devices in a packet transmission network, the packet transmission network comprising a plurality of network devices interconnected by one or more fabric channels to define a network topology having a plurality of data paths, the method executed by a network controller operably connected to each network device of the packet transmission network and comprising the steps of:
generating a computational model representative of data congestion at each node of a plurality of nodes disposed across the packet transmission network, wherein each data path of the plurality of data paths is defined across a subset of the plurality of nodes;
wherein the computational model is generated utilizing a combination of admission control protocols, data path selection protocols, knowledge of an instrumentation of each network device of the plurality of network devices, and knowledge of the network topology;
executing a bounded latency process on the computational model for each data path of the plurality of data paths;
wherein the bounded latency process identifies an optimal data path of the plurality of data paths for a requested virtual circuit, the bounded latency process comprising, for each data path of the packet transmission network, the steps of:
a) receiving a request for a new virtual circuit, the request comprising a plurality of parameters required by the new virtual circuit, the plurality of parameters including a maximum latency threshold, a minimum required bandwidth, and a maximum acceptable frame drop rate;
b) determining a total bandwidth allocated to each existing virtual circuit at each node of an instant data path;
c) comparing the minimum required bandwidth to a difference between the total bandwidth and a bandwidth capacity of each node of the instant data path;
d) identifying a bandwidth deficiency exists when the minimum required bandwidth exceeds the difference between the total bandwidth and the bandwidth capacity at any node of the instant data path;
e) determining whether the bandwidth deficiency is correctable via implementation of one or more corrective actions of a plurality of corrective actions;
f) wherein the plurality of corrective actions are selected from a group consisting of: adding one or more supplemental network devices to the packet transmission network, adding one or more hardware modifications to one or more network devices of the plurality of network devices, reconfiguring the packet transmission network, adjusting a scheduling protocol of one or more network devices of the plurality of network devices, selecting a new scheduling protocol for one or more network devices of the plurality of network devices, adding one or more redundant data paths for the new virtual circuit, rerouting one or more existing virtual circuits to a different data path, and reconfiguring a network access control of one or more network devices of the plurality of network devices;
g) implementing the one or more corrective actions identified in step (e) to correct the bandwidth deficiency;
h) rejecting the new virtual circuit if the plurality of corrective actions cannot correct the bandwidth deficiency;
i) determining a latency delay at each node of the instant data path;
j) summing the latency delay at each node of the instant data path to define a total latency delay of the instant data path;
k) comparing the total latency delay of the instant data path to the maximum latency threshold;
l) identifying a latency deficiency exists when the total latency delay exceeds the maximum latency threshold;
m) determining whether the latency deficiency is correctable via implementation of one or more corrective actions of the plurality of corrective actions;
n) implementing the one or more corrective actions identified in step (m) to correct the latency deficiency;
o) rejecting the new virtual circuit if the plurality of corrective actions cannot correct the latency deficiency;
p) determining an expected frame drop rate at each node of the instant data path;
q) comparing the expected frame drop rate to the maximum acceptable frame drop rate;
r) identifying a reliability resource deficiency exists when the expected frame drop rate exceeds the maximum acceptable frame drop rate;
s) determining whether the reliability resource deficiency is correctable via implementation of one or more corrective actions of the plurality of corrective actions;
t) implementing the one or more corrective actions identified in step (s) to correct the reliability resource deficiency;
u) rejecting the new virtual circuit if the plurality of corrective actions cannot correct the reliability resource deficiency;
v) determining available network access control resources at each node of the instant data path;
w) identifying a network access control resource deficiency when the available network access control resources at one or more nodes of the instant data path are insufficient to support the new virtual circuit;
x) determining whether the resource control deficiency is correctable via implementation of one or more corrective actions of the plurality of corrective actions;
y) implementing the one or more corrective actions identified in step (x) to correct the network access control resource deficiency;
z) rejecting the new virtual circuit if the plurality of corrective actions cannot correct the network access control resource deficiency;
aa) accepting the new virtual circuit if no bandwidth deficiency, latency deficiency, reliability resource deficiency, and network access control resource deficiency are identified; and
bb) configuring one or more field programmable gate arrays disposed on each network device of the plurality of network devices to implement the new virtual circuit using a network configuration protocol.

12. The method of claim 11, wherein the step of generating the computational model further comprises the steps of:
discovering the network topology of the packet transmission network via one or more network discovery protocols;
modeling the network topology as a port graph having a plurality of edges representing a connection between each node of the plurality of nodes; and
assigning a weight to each edge, the weight corresponding to a latency across the connection associated with the edge.

13. The method of claim 11, wherein the optimal data path is identified via implementing one or more protocols selected from a group consisting of: open shortest path first protocol, equal cost multipath protocol, rooted multipoint spanning tree protocol, and paired end point spanning tree protocol.

14. The method of claim 11, further comprising rejecting the virtual circuit subsequent to determining any of the bandwidth deficiency, the latency deficiency, the reliability resource deficiency, and the network access control resource deficiency are correctable by implementing one or more corrective actions of the plurality of corrective actions if the one or more corrective actions identified in any of steps (e), (m), (s), and (x) require operator intervention.

15. The method of claim 14, further comprising the step of notifying the operator of the one or more corrective actions that require operator intervention.

16. The method of claim 11, wherein each network device of the plurality of network devices is time-synchronized to a common grandmaster clock via a precision time protocol.

17. The method of claim 11, wherein the configuring step of step (bb) implemented by the network configuration protocol further comprises the steps of:
connecting to each network device of the plurality of network devices;
locking a candidate datastore of each network device, such that only the network configuration protocol implemented by the network controller is granted edit access to the candidate datastore;
wherein each candidate datastore comprises one or more network configuration datasets associated with the one or more proposed virtual circuits;
recording an initial network configuration dataset stored in each candidate datastore to create a save state of the initial network configuration dataset;
configuring each candidate datastore with a new network configuration dataset identified by the network controller to meet the plurality of parameters required by the new virtual circuit;
validating that the new virtual circuit meets the plurality of parameters using the new network configuration dataset across all nodes of the instant data path;
setting a validation flag to false if the new virtual circuit does not meet the plurality of parameters using the new network configuration dataset;
setting a validation flag to true if the new virtual circuit meets the plurality of parameters using the new network configuration dataset;
checking the validation flag;
restoring the candidate data store to the initial network configuration dataset if the validation flag is set to false;
committing the new network configuration dataset to the candidate datastore of each network device if the validation flag is true;
unlocking the candidate datastore of each network device.

18. The method of claim 17, wherein each candidate datastore is configured with the new network configuration dataset via the network configuration protocol executing, for each network device of the optimal data path, the steps of:
editing a forwarding table stored in the candidate datastore of an instant network device;
querying whether the instant network device comprises a terminal ingress device, a terminal egress device, or a transit device of the optimal data path;
editing the candidate datastore of the instant network device to create a virtual circuit label associated with the new virtual circuit if the instant network device is the terminal ingress device;
removing the virtual circuit label from the candidate datastore if the instant network device is the terminal egress device;
editing the candidate datastore of the instant network device to assign the new virtual circuit to a designated queue;
editing the candidate datastore of the instant network device to create a network ingress bandwidth profile and a network egress bandwidth profile, wherein the network ingress bandwidth profile and the network egress bandwidth profile comprise a user defined set of network access control parameters.

19. The method of claim 17, further comprising repeating the validating step a predetermined number of times if the new virtual circuit does not initially meet the plurality of parameters using the new network configuration dataset.

20. The method of claim 18, wherein the designated queue is selected on a per port and a per latency basis, such that all virtual circuits having similar latency parameters and passing through a shared port are assigned to a shared queue.
